(19) United States
(12) Patent Application Publication
(10) Pub. No.: US 2013/0102245 A1
(43) Pub. Date: Apr. 25, 2013

(54) RADIATION IMAGING SYSTEM AND PROCESSING METHOD THEREFOR

(71) Applicant: CANON KABUSHIKI KAISHA, Tokyo (JP)

(72) Inventor: Hirokazu Ohguri, Funabashi-shi (JP)

(73) Assignee: CANON KABUSHIKI KAISHA, Tokyo (JP)

(21) Appl. No.: 13/653,741

(22) Filed: Oct. 17, 2012

(30) Foreign Application Priority Data
Oct. 20, 2011 (JP) 2011-231099

(51) Int. Cl. H04B 7/00

(52) U.S. Cl. 455/39

(57) ABSTRACT

A radiation imaging system includes: a synchronous communication unit that performs synchronous communication for taking a radiation image via a wireless communication path before radiation is irradiated; a determination unit that determines that the radiation is to be irradiated when the synchronous communication has been performed, and that the radiation is not to be irradiated when the synchronous communication has not been performed; and a radiation image communication unit that performs radiation image communication for transmitting the radiation image via the wireless communication path after the radiation is irradiated. Values of communication parameters for the radiation image communication are set so as to exhibit the same or a higher tolerance for noise on the wireless communication path compared to values set to communication parameters for the synchronous communication.

### BACKGROUND OF THE INVENTION

1. Field of the Invention

The present invention relates to a radiation imaging system and a processing method therefor.

2. Description of the Related Art

There is a conventionally known radiation imaging system that takes a radiation image of a target by exposing the target to radiation (e.g. X-rays) and detecting the intensity distribution of the radiation that has passed through the target (hereinafter described as an X-ray imaging system).

For example, in such an X-ray imaging system, an X-ray generation apparatus irradiates the X-rays toward an object at a desired timing via synchronous communication with an X-ray imaging apparatus. The X-ray imaging apparatus digitalizes an X-ray image showing the intensity distribution of the X-rays that have passed through the object, and generates a final X-ray image by executing necessary image processing on the digitalized X-ray image.

In the above X-ray imaging system, an X-ray image obtained through the imaging is transferred to an image processing apparatus (e.g. a personal computer) for image processing and storage. After receiving the transferred X-ray image, the image processing apparatus displays the X-ray image that has been subjected to image processing on a display apparatus (e.g. a display).

For example, in recent years, a wired local area network (LAN) using unshielded twisted pair (UTP) cables and a wireless LAN are utilized in communication between an X-ray imaging apparatus and an X-ray generation apparatus so as to save space and enable easy installation (Japanese Patent Laid-Open No. 2011-041866). In particular, when wireless communication is performed with the X-ray imaging apparatus, flexibility in the installation of the X-ray imaging apparatus is significantly increased. This has the advantage of increasing flexibility in the imaging and easing the physical burden on an examinee during the imaging.

On the other hand, when wireless communication is used in the environment where other wireless LAN apparatuses exist around the X-ray imaging system, the wireless frequency bands used thereby may overlap depending on the status of communication. Likewise, in the case of Bluetooth (registered trademark) which is one of the wireless communication standards different from a wireless LAN, overlapping of the wireless frequency bands may occur because Bluetooth shares a part of the wireless frequency bands with the wireless LAN. In addition, there are cases where unwanted radio waves emitted by general electronic apparatuses such as microwave ovens interfere with the wireless frequency band used in wireless communication.

Such radio waves affecting wireless communication may occur in wireless frequency bands constantly, in pulses, or periodically. These radio waves, present in various forms, disturb wireless communication (hereinafter, they are referred to as noise). Therefore, the occurrence of such radio waves contributes to the obstruction of communication.

Should the aforementioned noise occur when, for example, the X-ray imaging apparatus transmits an X-ray image to the image processing apparatus, the error and loss of data occur more often than normal, and therefore retransmission processing has to be executed with great frequency. As a result, the image transfer may take longer than expected, or may fail due to disconnection of communication. In this case, the X-ray image generated by irradiating the X-rays toward the examinee would be lost, thus subjecting the examinee to unnecessary exposure.

One possible way to solve the above problem is to use synchronous communication performed between the X-ray imaging apparatus and the X-ray generation apparatus before the X-ray irradiation. More specifically, it is assumed that failure in synchronous communication due to the occurrence of noise in wireless frequency bands gives rise to the possibility that communication for the image transfer could also fail. Therefore, when synchronous communication fails, the X-ray irradiation is not permitted. In other words, when synchronous communication succeeds, the image transfer is assumed to succeed as well, and therefore the X-ray irradiation is permitted

In general, however, synchronous communication and image transfer are performed under the best conditions suited for their respective purposes. Reliable communication is required in synchronous communication, and the amount of information carried via synchronous communication is very small. Therefore, synchronous communication uses, for example, the transmission control protocol (TCP) as a communication protocol, and a packet length therefor is several tens of bytes.

In contrast, the image transfer requires transmission of a large amount of data in a short period of time. Therefore, the image transfer uses, for example, the user datagram protocol (UDP) as a communication protocol, and a packet length therefor is set as long as possible (e.g. several thousand bytes) so as to reduce the overhead.

As set forth above, although synchronous communication and image transfer are both performed in the form of wireless communication, communication parameters therefor are set differently in accordance with the uses thereof, and therefore the tolerance for noise differs between synchronous communication and image transfer. In the above example, the tolerance for noise is higher in the synchronous communication than in the image transfer. Under such a circumstance, whether the image transfer succeeds or fails cannot be determined based on whether the synchronous communication succeeds or fails.

### SUMMARY OF THE INVENTION

The present invention has been made in view of the above problem, and provides technology for permitting a radiation image to be taken only when the success of transmission of the taken radiation image is guaranteed.

According to one aspect of the present invention, there is provided a radiation imaging system comprising: a synchronous communication unit configured to perform synchronous communication for taking a radiation image via a wireless communication path before radiation is irradiated; a determination unit configured to determine that the radiation is to be irradiated when the synchronous communication has been performed, and that the radiation is not to be irradiated when the synchronous communication has not been performed; and a radiation image communication unit configured to perform radiation image communication for transmitting the radiation image via the wireless communication path after the radiation is irradiated, wherein values of communication parameters for the radiation image communication are set so as to exhibit the same or a higher tolerance for noise on the wireless communication path compared to values set to communication parameters for the synchronous communication.

According to the present invention, a radiation image is permitted to be taken only when the success of transmission of the taken radiation image is guaranteed. This can prevent an increase in the amount of time required to transmit the radiation image and the loss of the radiation image, thus preventing the examinee from experiencing unnecessary exposure.

Further features of the present invention will become apparent from the following description of exemplary embodiments (with reference to the attached drawings).

### BRIEF DESCRIPTION OF THE DRAWINGS

FIG. 1 shows an example of a configuration of an X-ray imaging system 10 according to one embodiment of the present invention.

FIG. 2 shows examples of communication parameters for synchronous communication and image data communication.

FIG. 3 shows examples of packet configurations for the synchronous communication and the image data communication.

FIG. 4 is a sequence chart showing an example of a flow of processing executed in the X-ray imaging system.

FIG. 5 is a sequence chart showing an example of a flow of processing executed in the X-ray imaging system.

FIG. 6 shows examples of communication parameters for the synchronous communication and the image data communication.

FIG. 7 shows an example of functional configurations realized in the X-ray imaging system.

FIGS. 8A to 8B are flowcharts showing an example of a flow of processing executed in the X-ray imaging system.

FIG. 9 is a diagram for explaining an outline of processing executed in an X-ray imaging system 10 according to Embodiment 2.

### DESCRIPTION OF THE EMBODIMENTS

The following describes embodiments of the present invention in detail with reference to the drawings. Note that although the following embodiments describe examples in which the X-rays are used as radiation, radiation is not limited to the X-rays but may instead be electromagnetic waves, 60 rays, β rays, γ rays, and the like.

### Embodiment 1

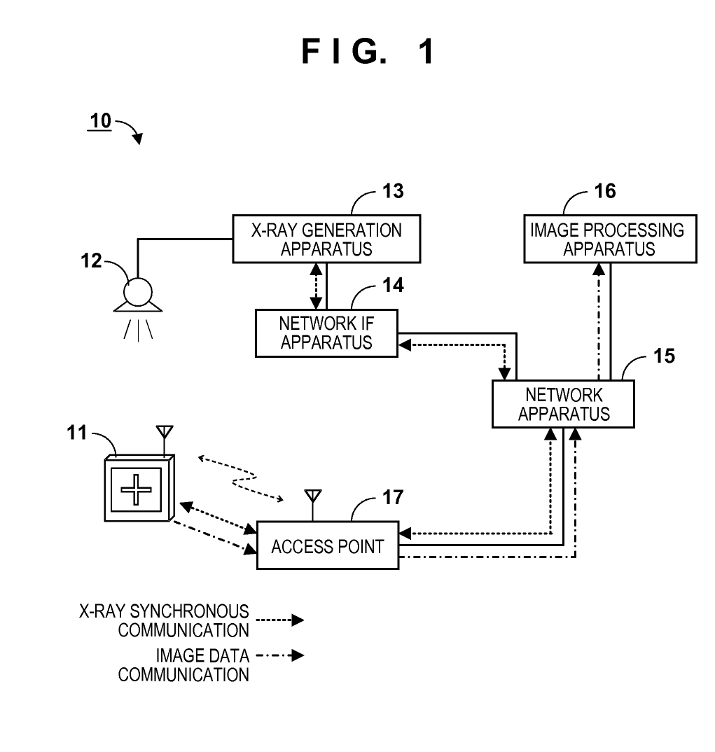

FIG. 1 shows an example of a configuration of a radiation imaging system according to one embodiment of the present invention (in the present embodiment, an X-ray imaging system).

An X-ray imaging system 10 takes an X-ray image of a target (object) by irradiating the X-rays (radiation) toward the target and detecting the intensity distribution of the X-rays that have passed through the target. The X-ray imaging system 10 includes an X-ray imaging apparatus 11, an X-ray tube 12, an X-ray generation apparatus 13, a network interface (IF) apparatus 14, a network apparatus 15, an image processing apparatus 16, and an access point 17.

At least parts of the X-ray imaging apparatus 11, the X-ray generation apparatus 13 and the image processing apparatus 16 are connected via wireless communication paths. A description is now given of the specific status of connection between the apparatuses included in the X-ray imaging system 10. The X-ray generation apparatus 13 and the network IF apparatus 14 are connected via a dedicated wire cable. The network apparatus 15, the network IF apparatus 14, the image processing apparatus 16 and the access point 17 are connected via, for example, UTP cables. The access point 17 and the X-ray imaging apparatus 11 are connected such that they can wirelessly communicate with each other (via a wireless LAN in the present embodiment). It is understood that this wireless communication may be realized using other communication methods such as Bluetooth (registered trademark), in which case apparatus configurations may be changed as appropriate.

The X-ray imaging apparatus (radiography apparatus) 11 includes a flat-panel X-ray detector (X-ray detection unit). The X-ray detector executes preparatory operations prior to the X-ray irradiation. Thereafter, the X-ray detector enters an accumulation mode and accumulates charges dependent on the intensity distribution of the X-rays that have passed through the object in a sensor. The X-ray detector then reads the accumulated charges and generates X-ray image data. Note that the preparatory operations are executed to release the charges accumulated in the sensor using dark current in advance, and are necessary to improve the image quality and secure a dynamic range. The X-ray imaging apparatus 11 also includes a wireless communication unit for performing wireless communication, and performs synchronous communication and image data communication via the wireless communication unit.

The X-ray tube 12 generates the X-rays. The X-ray generation apparatus (radiation generation apparatus) 13 controls the X-ray tube 12 to irradiate the X-rays toward the object (that is to say, the examinee). The X-ray generation apparatus 13 includes an irradiation switch. The operator presses down the irradiation switch at a predetermined timing. This starts the shooting of the X-ray image.

The network IF apparatus 14 controls communication between the X-ray generation apparatus 13 and the network apparatus 15. The network apparatus 15 controls communication among the network IF apparatus 14, the image processing apparatus 16 and the access point 17. The access point 17 controls communication between the network apparatus 15 and the X-ray imaging apparatus 11. As has been mentioned earlier, the access point 17 communicates with the network apparatus 15 using a UTP cable, and wirelessly communicates with the X-ray imaging apparatus 11 using a wireless LAN.

The image processing apparatus 16 receives the X-ray image data generated by the X-ray imaging apparatus 11 via the access point 17 and the network apparatus 15, executes image processing and the like on the image data, and stores the image data therein. The image processing apparatus 16 displays the X-ray image that has been subjected to image processing on a display apparatus (e.g. a display).

In the X-ray imaging system 10, synchronous communication and image data communication (transmission of image data) are performed when taking the X-ray image.

Before the X-rays are irradiated toward the object, synchronous communication is performed between the X-ray generation apparatus 13 and the X-ray imaging apparatus 11 in association with the shooting of the X-ray image. For example, in synchronous communication, an irradiation permission request signal and an irradiation permission signal are exchanged.

The irradiation permission request signal is transmitted from the X-ray generation apparatus 13 to the X-ray imaging apparatus 11 via the intervening apparatuses when an instruction for taking the X-ray image has been issued to the X-ray generation apparatus 13. Upon reception of this signal, the X-ray detector in the X-ray imaging apparatus 11 starts the preparatory operations and the operation for accumulating charges. The irradiation permission signal is transmitted from the X-ray imaging apparatus 11 to the X-ray generation apparatus 13 via the intervening apparatuses when the X-ray detector has completed the preparatory operations and the like.

Meanwhile, image data communication is performed between the X-ray imaging apparatus 11 and the image processing apparatus 16 in association with transmission of the X-ray image. In the image data communication, the X-ray image data is transmitted from the X-ray imaging apparatus 11 to the image processing apparatus 16 after the X-ray irradiation.

This concludes the description of an example of a configuration of the X-ray imaging system 10 according to the present embodiment. It should be noted that the above-described configuration is merely an example and may be changed as appropriate. For example, the network IF apparatus 14 and the network apparatus 15 may be realized as a part of functions of the X-ray generation apparatus 13, or may be realized as a part of functions of another apparatus.

Furthermore, computers are built into the above-described X-ray generation apparatus 13, network IF apparatus 14, network apparatus 15, image processing apparatus 16, and the like. These computers include a main control unit such as a central processing unit (CPU) and a storage unit such as a read-only memory (ROM), a random-access memory (RAM) and a hard disk drive (HDD). These computers also include other constituents such as input/output units, examples of which include a display, buttons and a touchscreen. These constituents are connected by a bus and the like, and controlled by the main control unit executing programs stored in the storage unit.

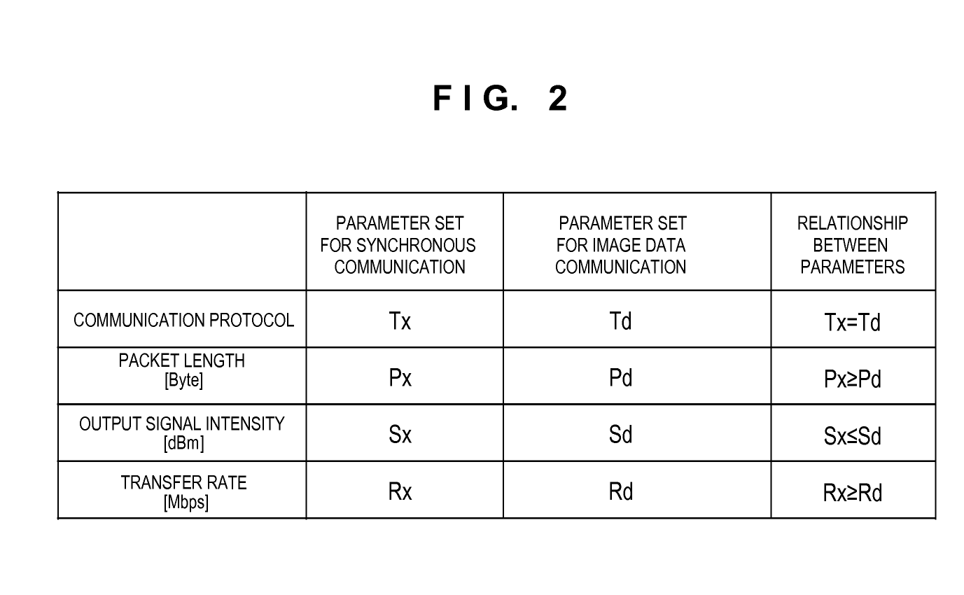

With reference to FIG. 2, the following describes examples of relationships between communication parameters relating to communication involving the irradiation permission request signal and the irradiation permission signal (hereinafter referred to as communication parameters for synchronous communication) and communication parameters relating to transmission of the X-ray image data (hereinafter referred to as communication parameters for image data communication).

In FIG. 2, communication protocols, packet lengths, output signal intensities and transfer rates are shown as the communication parameters relating to synchronous communication and transmission of the image data. Among these communication parameters, the communication protocols Tx and Td that are respectively used in the synchronous communication and the image data communication are the same (Tx=Td). Examples of communication protocols used in a transport layer of an OSI reference model include TCP and UDP. The same protocol (e.g., TCP or UDP) may be set as the communication protocol Tx for the synchronous communication and the communication protocol Td for the image data communication.

Other communication parameters, e.g. the communication parameters for synchronous communication such as the packet length, the output signal intensity and the transfer rate, are set in consideration of noise that could occur on the wireless communication path between the X-ray imaging apparatus 11 and the access point 17. More specifically, these communication parameters are set such that the tolerance for noise that could occur on the wireless communication path in the synchronous communication is equal to or lower than that in the image data communication.

For example, as to the packet lengths, the packet length Px [byte] for the synchronous communication and the packet length Pd [byte] for the image data communication satisfy the relationship Px Pd. That is to say, the packet length Px for the synchronous communication is set to be equal to or longer than the packet length Pd for the image data communication. By thus setting the communication parameters associated with the packet lengths, the tolerance for noise that could occur on the wireless communication path in the synchronous communication is equal to or lower than that in the image data communication.

On the other hand, as to the output signal intensities, the output signal intensity Sx [dBm] for the synchronous communication and the output signal intensity Sd [dBm] for the image data communication satisfy the relationship Sx≦Sd. That is to say, the output signal intensity Sd for the image data communication is set to be equal to or higher than the output signal intensity Sx for the synchronous communication. By thus setting the communication parameters associated with the output signal intensities, the tolerance for noise that could occur on the wireless communication path in the synchronous communication is equal to or lower than that in the image data communication.

On the other hand, as to the wireless transfer rates, the transfer rate Rx [Mbps] for the synchronous communication and the transfer rate Rd [Mbps] for the image data communication satisfy the relationship Rx≧Rd. That is to say, the transfer rate Rx for the synchronous communication is set to be equal to or higher than the transfer rate Rd for the image data communication. By thus setting the communication parameters associated with the wireless transfer rates, the tolerance for noise that could occur on the wireless communication path in the synchronous communication is equal to or lower than that in the image data communication.

Although the communication protocols, the packet lengths, the output signal intensities and the transfer rates have been explained above as examples of the communication parameters, the communication parameters are not limited to these, and may be any communication parameters used in communication via wireless communication paths. Furthermore, the communication parameters that satisfy the aforementioned relationship (the relationship between high and low tolerances for noise) are not limited to being in one-to-one correspondence, but may instead be in one-to-many correspondence and the like.

Furthermore, the X-ray generation apparatus 13 may notify the X-ray imaging apparatus 11 of the values set to the communication parameters shown in FIG. 2 by including them in a packet for the synchronous communication as user data. It is understood that this notification may be conducted using other methods. For example, communication for delivering such information may be independently performed. Alternatively, such information may be notified by being included in a beacon signal output from the access point 17.

Considering the amount of information that is essentially necessary for communication, it is sufficient to use a packet of several tens of bytes constituted by a communication command, an ID, various types of headers, error detection codes, and the like for the irradiation permission request signal and the irradiation permission signal. However, in the configuration of the present embodiment, the packet length is increased to several thousand bytes, which is similar to the packet length for the image data communication.

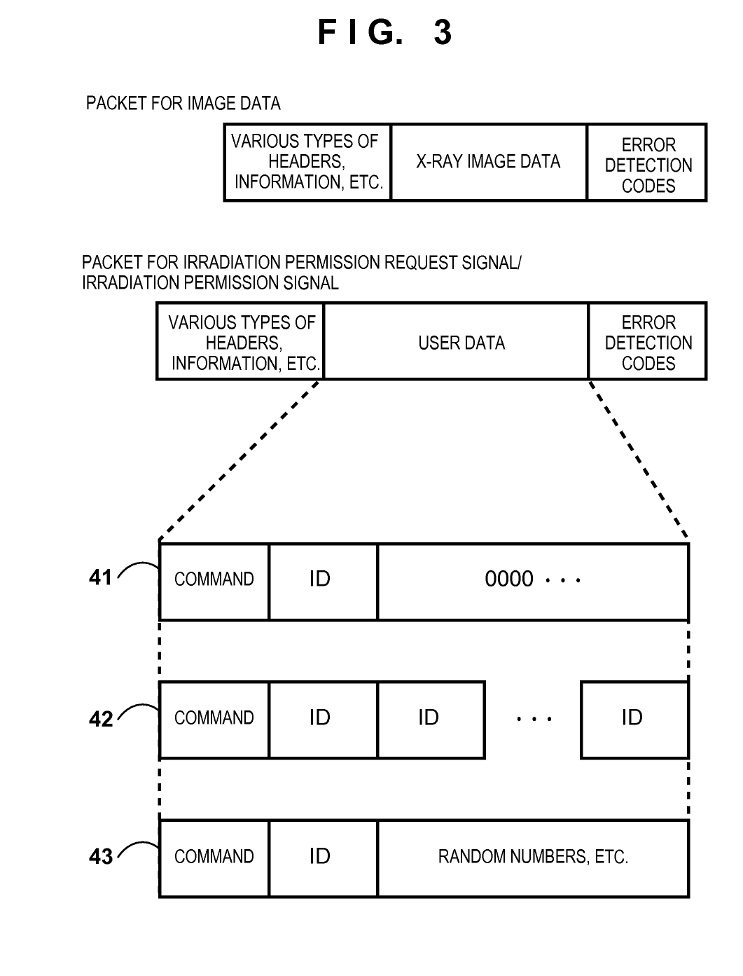

For example, the packet length can be increased by adding 0 (or 1) as padding data to the constituent elements of the packet (reference sign 41), or by repeating time information as the ID to fill the required size (reference sign 42), as shown in FIG. 3. Alternatively, the packet length may be increased using any other method, e.g. by using values such as random numbers to fill the required size (reference sign 43).

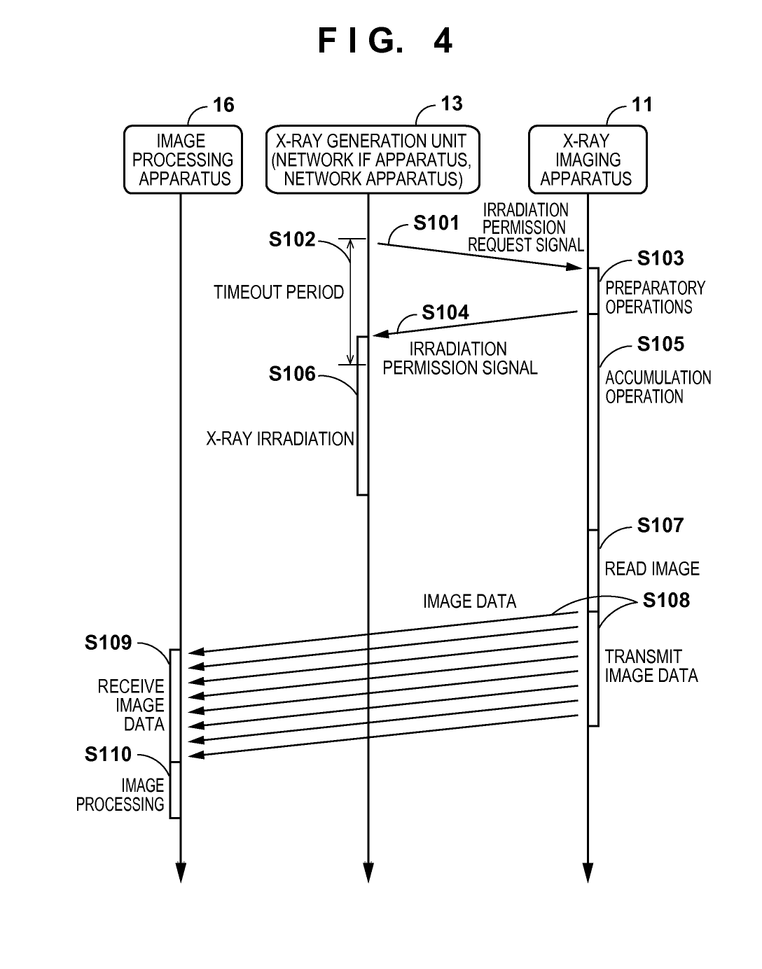

With reference to FIG. 4, the following describes an example of a flow of processing executed in the X-ray imaging system 10 shown in FIG. 1. More specifically, the following describes a flow of processing for taking an X-ray image.

As to the communication parameters for the synchronous communication, UDP is used as the communication protocol, the packet length is Px [byte], the output signal intensity is Sx [dBm], and the transfer rate is Rx [Mbps] in the following example. Px, Sx and Rx vary depending on a system structure to which the present invention is applied and on the specification required for the system. The values of Px, Sx and Rx may be selected as appropriate when performing wireless communication.

The present processing is started when the operator presses down the irradiation switch provided in the X-ray generation apparatus 13. When the irradiation switch is pressed down, before the X-ray tube 12 irradiates the X-rays, the X-ray generation apparatus 13 (network IF apparatus 14) generates an irradiation permission request signal and transmits the same to the X-ray imaging apparatus 11 (S101). At this time, the X-ray generation apparatus 13 (network IF apparatus 14) also starts measuring time using a timer (S102). The irradiation permission request signal includes a unique request signal ID and values set to the communication parameters for the synchronous communication. For example, the request signal ID may be generated by using the current time measured by a clock (not shown in the figures) built into the X-ray generation apparatus 13 (network IF apparatus 14), or by generating a random number each time. After passing through the network apparatus 15 and the access point 17, the irradiation permission request signal arrives at the X-ray imaging apparatus 11 via wireless communication.

When the X-ray imaging apparatus 11 receives the irradiation permission request signal, the X-ray detector therein executes preparatory operations (S103). Also, the X-ray imaging apparatus 11 acquires the values set to the communication parameters for the synchronous communication from the irradiation permission request signal, and sets the values of the communication parameters for the image data communication based on the acquired values.

When the X-ray detector has completed the preparatory operations, the X-ray imaging apparatus 11 transmits an irradiation permission signal to the X-ray generation apparatus 13 (S104) and starts the operation for accumulating charges (S105). The irradiation permission signal includes the aforementioned request signal ID. After passing through the access point 17 and the network apparatus 15, the irradiation permission signal is transmitted to the X-ray generation apparatus 13 via the network IF apparatus 14.

Upon receiving the irradiation permission signal, the X-ray generation apparatus 13 (network IF apparatus 14) determines whether or not it received the irradiation permission signal within a predetermined timeout period with reference to the timer that started to measure time in the process of S102. The X-ray generation apparatus 13 also determines whether or not the ID included in the received irradiation permission signal matches the request signal ID transmitted in the process of S101. When both of the conditions of the results of determination are satisfied, the X-ray generation apparatus 13 performs the X-ray irradiation (S106).

Various types of wireless communication may be affected by noise. In the present case, however, the X-ray irradiation is performed because the synchronous communication succeeded within the timeout period measured by the timer in the X-ray generation apparatus 13. That is to say, the X-ray irradiation is performed under the assumption that, because the synchronous communication that has a lower resistance to noise than the image data communication succeeded, the image data communication to be performed thereafter should succeed in data communication as well.

Note that the X-ray generation apparatus 13 does not perform the X-ray irradiation when it did not receive the irradiation permission signal within the timeout period. Even if the irradiation permission signal is received after the timeout period has elapsed, the X-ray irradiation is not started. Furthermore, the X-ray generation apparatus 13 also does not perform the X-ray irradiation when the request signal ID included in the received irradiation permission signal does not match the transmitted request signal ID because the irradiation permission signal is not effective in that case.

After the X-ray generation apparatus 13 has started the X-ray irradiation, it continues the X-ray irradiation until the pressed-down state of the irradiation switch is released, or until a predetermined maximum irradiation period elapses. Note that the X-ray imaging apparatus 11 has acquired the timeout period and the maximum irradiation period ahead of time, and at least maintains the state in which the charges are accumulated until the following period elapses: “timeout period+maximum irradiation period−time period of preparatory operations”.

When the X-ray imaging apparatus 11 detects that the above period has elapsed, it reads the accumulated charges and generates X-ray image data based on the accumulated charges (S107). The X-ray imaging apparatus 11 then transmits the generated X-ray image data to the image processing apparatus 16 (S108). Here, as to the communication parameters for the image data communication, UDP is used as the communication protocol as with the synchronous communication, the packet length is Pd=Px−p [byte], the output signal intensity is Sd=Sx+s [dBm], and the transfer rate is Rd=Rx−r [Mbps]. Note that p, s and r are either 0 or a positive value. The values of p, s and r may be set as appropriate such that the values of Pd, Sd and Rd are appropriate for wireless communication.

With the above settings, the image data communication uses the same communication protocol as the synchronous communication. Furthermore, the image data communication is performed with a packet length that is equal to or shorter than a packet length used in the synchronous communication, an output signal intensity that is equal to or higher than an output signal intensity used in the synchronous communication, and a transfer rate that is equal to or lower than a transfer rate used in the synchronous communication. As has been mentioned above, because the synchronous communication is performed normally within the timeout period, a normal performance of the image data communication is guaranteed.

Thereafter, the image processing apparatus 16 receives the transmitted X-ray image data (S109) and executes predetermined image processing (S110). The X-ray image data is then transmitted to and displayed on the display apparatus and the like.

Note that the X-ray irradiation is not performed when the irradiation permission request signal has been lost without arriving at the X-ray imaging apparatus 11 due to the effect of noise on the wireless communication path, or when the X-ray imaging apparatus 11 cannot properly receive the irradiation permission request signal even though the irradiation permission request signal arrived at the X-ray imaging apparatus 11. Likewise, the X-ray irradiation is also not performed when the irradiation permission signal has been lost without arriving at the X-ray generation apparatus 13, or when the X-ray generation apparatus 13 cannot properly receive the irradiation permission signal even though the irradiation permission signal arrived at the X-ray generation apparatus 13. Furthermore, the X-ray irradiation is also not performed when the timeout period has elapsed.

In the above cases, the operator needs to release the irradiation switch and then press down the irradiation switch again. At this time, a notification about the failure of the synchronous communication, or a request to press down the irradiation switch again, may be displayed to the operator.

When the X-ray imaging apparatus 11 has received the irradiation permission request signal and started the preparatory operations, it subsequently executes the accumulation operation, the reading operation and the transmission of image data, regardless of whether or not the X-ray irradiation has been performed. These operations neither impair the safety of the examinee nor cause adverse effects on the apparatuses. When a new irradiation permission request signal has been received before these operations are completed, these operations may be stopped, and the preparatory operations corresponding to the new irradiation permission request signal may be started.

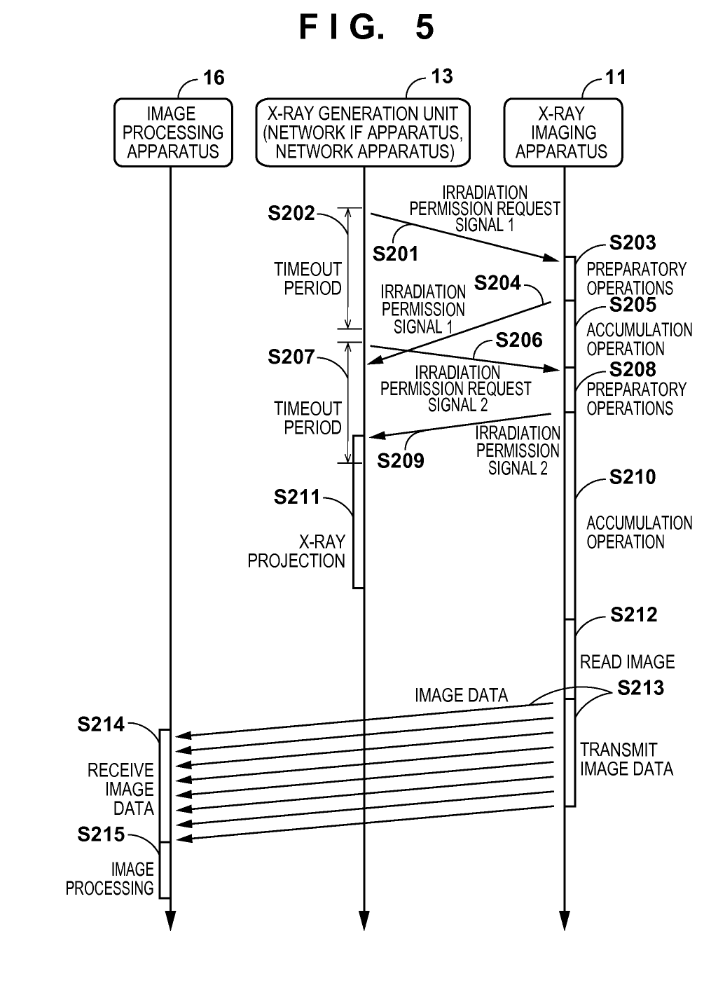

With reference to FIG. 5, the following describes an example of a flow of processing executed in the X-ray imaging system 10 shown in FIG. 1. More specifically, the following describes the operations executed when the synchronous communication fails due to the effect of noise on the wireless communication paths.

As with the case of FIG. 4 explained above, when the present processing is started, the X-ray generation apparatus 13 (network IF apparatus 14) generates an irradiation permission request signal 1 and transmits the same to the X-ray imaging apparatus 11 (S201). The X-ray generation apparatus 13 also starts measuring time using a timer (S202). When the X-ray imaging apparatus 11 receives the irradiation permission request signal, the X-ray detector therein executes preparatory operations (S203). Also, the X-ray imaging apparatus 11 transmits an irradiation permission signal 1 to the X-ray generation apparatus 13 (S204).

With regard to the irradiation permission request signal 1 and the irradiation permission signal 1 (hereinafter referred to as synchronous communication 1), UDP is used as the communication protocol, the packet length is Px1 [byte], the output signal intensity is Sx1 [dBm], and the transfer rate is Rx1 [Mbps].

It is assumed here that a delay has occurred in the synchronous communication 1 due to the effect of noise, and therefore the timeout period has elapsed. In this case, the operator releases the irradiation switch and then presses down the irradiation switch again.

When the irradiation switch is pressed down again, the X-ray generation apparatus 13 generates an irradiation permission request signal 2 that includes an ID different from the ID included in the irradiation permission request signal 1, and transmits the irradiation permission request signal 2 to the X-ray imaging apparatus 11 (S206).

Note that the relationship between the communication parameters for the synchronous communication 1 and the communication parameters for the irradiation permission request signal 2 and an irradiation permission signal 2 (hereinafter referred to as synchronous communication 2) is similar to the relationship between the communication parameters for the synchronous communication and the communication parameters for the image data communication described with reference to FIG. 4 and the like. That is to say, in the synchronous communication 2, UDP is used as the communication protocol as with the synchronous communication 1, the packet length is Px2=Px1−p1 [byte], the output signal intensity is Sx2=Sx1+s1 [dBm], and the transfer rate is Rx2=Rx1−r1 [Mbps]. Note that p1, s1 and r1 are either 0 or a positive value. The values of p1, s1 and r1 are selected such that the values of Px2, Sx2 and Rx2 are appropriate for wireless communication. That is to say, the settings are such that the tolerance for noise in the synchronous communication 2 is equal to or higher than that in the synchronous communication 1.

With the communication parameters set in the above manner, when the synchronous communication 2 is performed normally within the timeout period (S207 to S209), the X-ray generation apparatus 13 starts the X-ray irradiation (S211). The X-ray imaging apparatus 11 executes the accumulation operation (S210) and the reading operation (S212), and the X-ray image data obtained through these operations is transmitted to the image processing apparatus 16 (S213 to S215).

Here, the relationship between the communication parameters for the synchronous communication 2 and the communication parameters for the image data communication is similar to the relationship between the communication parameters for the synchronous communication and the communication parameters for the image data communication described with reference to FIG. 4 and the like. That is to say, in the image data communication, UDP is used as the communication protocol as with the synchronous communication 2, the packet length is Pd=Px2−p2 [byte], the output signal intensity is Sd=Sx2+s2 [dBm], and the transfer rate is Rd=Rx2−r2 [Mbps]. Note that p2, s2 and r2 are either 0 or a positive value. The values of p2, s2 and r2 are selected such that the values of Pd, Sd and Rd are appropriate for wireless communication. Magnitude relationships between p1 and p2, between s1 and s2, and between r1 and r2 are not taken into account. In the above manner, the settings are such that the tolerance for noise in the image data communication is equal to or higher than that in the synchronous communication 2.

With the communication parameters for the image data communication set in the above manner, a success in the synchronous communication 2 guarantees a normal transmission of image data.

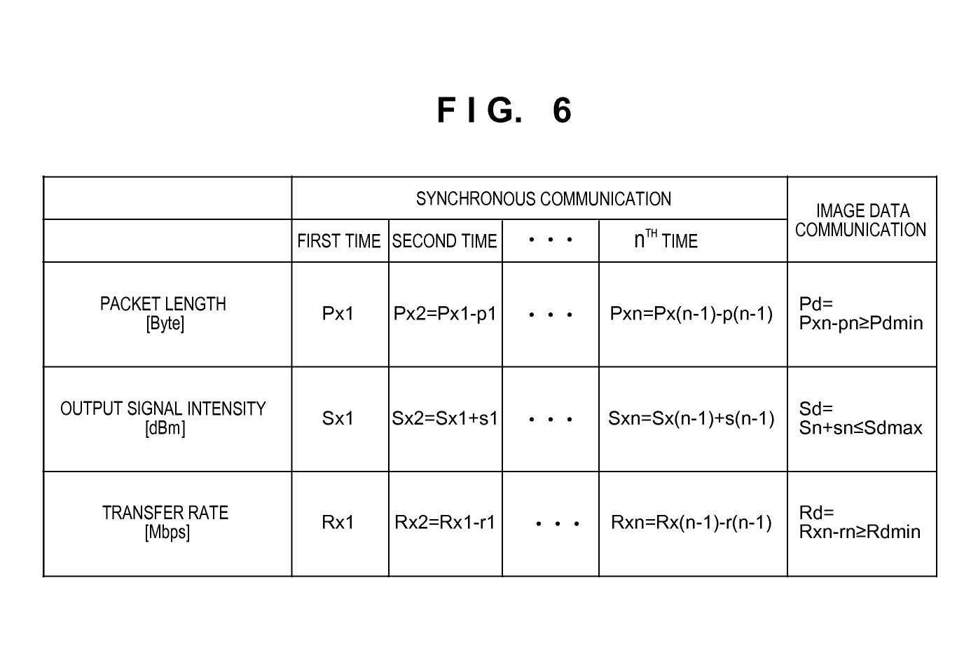

Although FIG. 5 shows the example in which the synchronous communication succeeds after transmitting the irradiation permission request twice, it is understood that the number of times the irradiation permission request is transmitted until the synchronous communication succeeds is not limited to two. As shown in FIG. 6, processing may be executed repeatedly, either for a predetermined number of times or until the synchronous communication succeeds, while updating the communication parameters Pxn, Sxn, Rxn, Pd, Sd and Rd using pn, sn and rn (n is a natural number) such that the aforementioned relationship (the relationship between high and low tolerances for noise) is satisfied.

In practice, settings of communication parameters that cannot be allowed in view of the specification of image transfer (image data communication) and settings that are impossible in terms of system configurations commonly exist. For example, a maximum time period that can be allowed as a time period of image transfer is determined by the specification required for the system. Therefore, a transfer rate that does not satisfy this condition cannot be set. Furthermore, a signal with a settable maximum output intensity is determined by the specifications of the apparatuses. A minimum packet length Pdmin, a maximum output signal intensity Sdmax and a minimum transfer rate Rdmin that can be set for the image transfer are determined in view of the above conditions. Based on these, the values of pn, sn and rn and the number of repetitions may be determined.

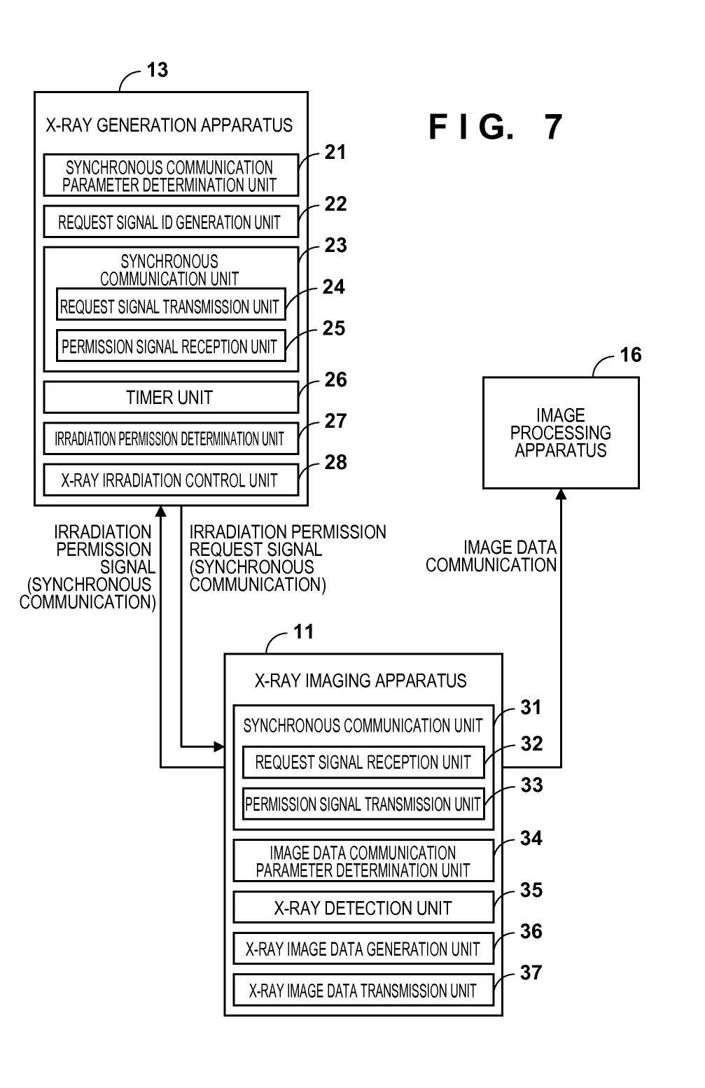

With reference to FIG. 7, the following describes an example of functional configurations realized in the X-ray imaging system 10 shown in FIG. 1. More specifically, the following describes functional configurations realized by the X-ray generation apparatus 13, the X-ray imaging apparatus 11 and the image processing apparatus 16.

The X-ray generation apparatus 13 includes, as its functional constituents, a synchronous communication parameter determination unit 21, a request signal ID generation unit 22, a synchronous communication unit 23, a timer unit 26, an irradiation permission determination unit 27 and an X-ray irradiation control unit 28.

The synchronous communication parameter determination unit 21 determines (values set to) the communication parameters for synchronous communication. The request signal ID generation unit 22 generates a request signal ID to be included in an irradiation permission request signal when transmitting the irradiation permission request signal. This ID is generated using a unique value.

The synchronous communication unit 23 has a function of performing synchronous communication and is composed of a request signal transmission unit 24 and a permission signal reception unit 25. When the operator has pressed down the irradiation switch, the request signal transmission unit 24 transmits the irradiation permission request signal to the X-ray imaging apparatus 11. As has been mentioned earlier, the irradiation permission request signal includes the request signal ID and the communication parameters for the synchronous communication. The permission signal reception unit 25 receives an irradiation permission signal that is transmitted from the X-ray imaging apparatus 11 in response to the transmission of the irradiation permission request signal.

The timer unit 26 measures time from when the irradiation permission request signal is transmitted to when a response signal (the irradiation permission signal) corresponding to the request signal is received. In other words, the timer unit 26 measures time from when the synchronous communication is started to when the synchronous communication is completed.

The irradiation permission determination unit 27 determines whether or not to permit the X-ray irradiation based on whether or not the irradiation permission signal is effective. The X-ray irradiation control unit 28 controls irradiation of the X-rays by the X-ray tube 12 in accordance with the result of determination made by the irradiation permission determination unit 27.

The X-ray imaging apparatus 11 includes, as its functional constituents, a synchronous communication unit 31, an image data communication parameter determination unit 34, an X-ray detection unit 35, an X-ray image data generation unit 36 and an X-ray image data transmission unit 37.

The synchronous communication unit 31 has a function of performing synchronous communication and is composed of a request signal reception unit 32 and a permission signal transmission unit 33. The request signal reception unit 32 receives the irradiation permission request signal transmitted from the X-ray generation apparatus 13. The permission signal transmission unit 33 transmits the irradiation permission signal to the X-ray generation apparatus 13 in accordance with the communication parameters for the synchronous communication included in the irradiation permission request signal.

The image data communication parameter determination unit 34 determines (values set to) the communication parameters for the image data communication (radiation image communication) based on the values set to the communication parameters for the synchronous communication included in the irradiation permission request signal.

The X-ray detection unit 35 detects the intensity distribution of the X-rays that have passed through the target (object). As has been mentioned earlier, the X-ray detection unit 35 is realized by, for example, a flat-panel X-ray detector.

The X-ray image data generation unit 36 generates the X-ray image data based on the result of detection by the X-ray detection unit 35. The X-ray image data transmission unit (radiation image communication unit) 37 transmits the X-ray image data to the image processing apparatus 16 in accordance with the communication parameters for the image data communication set by the image data communication parameter determination unit 34.

This concludes the description of an example of functional configurations realized by the X-ray generation apparatus 13, the X-ray imaging apparatus 11 and the image processing apparatus 16. Note that the constituents shown in FIG. 7 need not necessarily be arranged exactly as shown therein, as long as they are realized in any of the apparatuses included in the X-ray imaging system 10. For example, a part of functions of the X-ray generation apparatus 13 may be realized by the network IF apparatus 14. More specifically, the network IF apparatus 14 may, for example, generate the request signal ID.

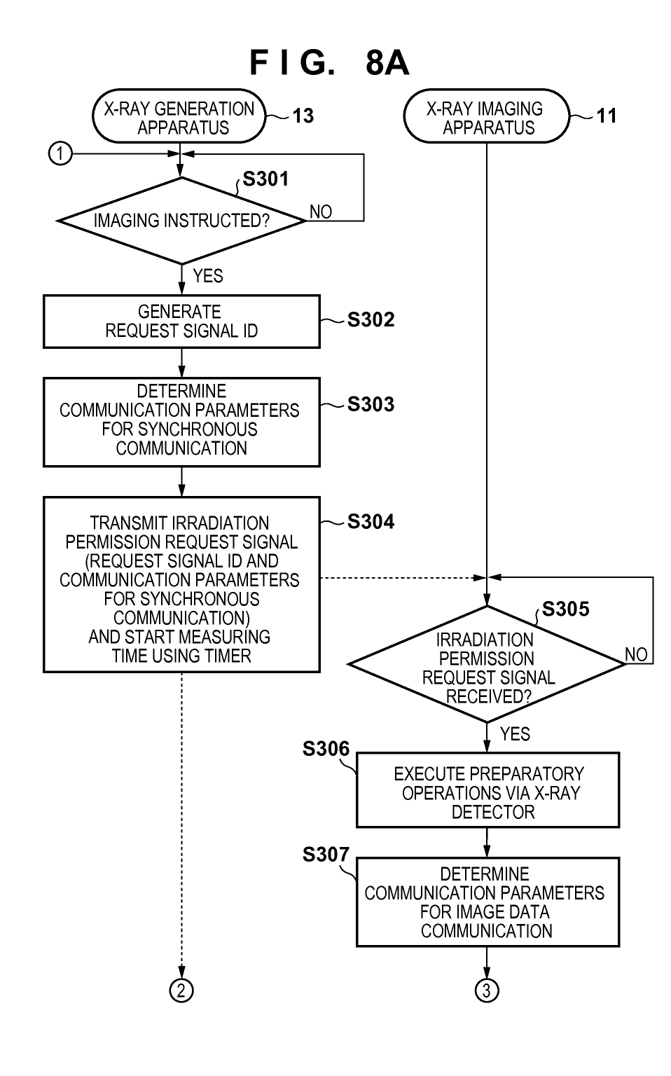

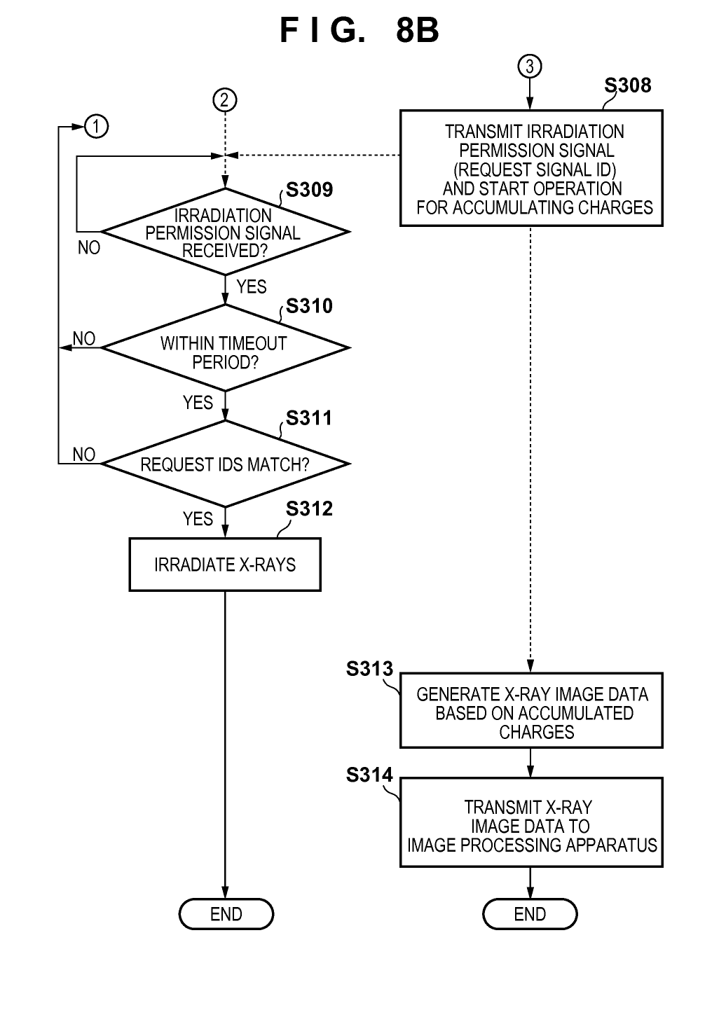

With reference to FIGS. 8A to 8B, the following describes a flowchart of an example of processing executed in the X-ray imaging system 10 shown in FIG. 1.

The present processing is started when the operator presses down the irradiation switch provided to the X-ray generation apparatus 13 (S301). When the present processing is started, in the X-ray generation apparatus 13, the request signal ID generation unit 22 generates a request signal ID (S302), and the synchronous communication parameter determination unit 21 determines the communication parameters for synchronous communication (S303). The request signal transmission unit 24 transmits a irradiation permission request signal including the request signal ID and the communication parameters for the synchronous communication to the X-ray imaging apparatus 11. At this time, the timer unit 26 in the X-ray generation apparatus 13 starts measuring time using a timer (S304).

In the X-ray imaging apparatus 11, when the request signal reception unit 32 receives the irradiation permission request signal (the YES branch of S305), the X-ray detection unit 35 (X-ray detector) executes preparatory operations (S306). Furthermore, in the X-ray imaging apparatus 11, the image data communication parameter determination unit 34 determines the communication parameters for the image data communication based on the communication parameters for the synchronous communication included in the irradiation permission request signal (S307). Then, the permission signal transmission unit 33 transmits an irradiation permission signal including the request signal ID included in the irradiation permission request signal to the X-ray generation apparatus 13. At this time, in the X-ray imaging apparatus 11, the X-ray detection unit 35 also starts the operation for accumulating charges (S308). Note that the transmission of this irradiation permission request signal (namely, the synchronous communication) is performed in accordance with the communication parameters for the synchronous communication included in the irradiation permission request signal that was received in the process of S305.

In the X-ray generation apparatus 13, when the permission signal reception unit 25 receives the irradiation permission signal (the YES branch of S309), the irradiation permission determination unit 27 determines whether or not to permit the X-ray irradiation. To be more specific, the irradiation permission determination unit 27 determines whether or not the irradiation permission signal was received within the timeout period that the timer started to measure in S304, and whether or not the request signal ID included in the irradiation permission signal matches the request signal ID that was included in the irradiation permission request signal in the process of S303.

When the result of this determination shows that the irradiation permission signal was not received within the timeout period (the NO branch of S310), or that the request signal IDs do not match (the NO branch of S311), the X-ray generation apparatus 13 does not perform the X-ray irradiation and returns to the process of S301 again. Note that when the above processes are executed again in sequence starting from S301, a unique request signal ID that differs from the previously-generated request signal ID is generated in the process of S302. Furthermore, in the process of S303, the values of the communication parameters for the synchronous communication are re-set so as to exhibit the same or a higher tolerance for noise compared to the communication parameters previously used.

On the other hand, when the irradiation permission signal was received within the timeout period (the YES branch of S310) and the request signal IDs match (the YES branch of S311), the X-ray generation apparatus 13 performs the X-ray irradiation (S312).

In the X-ray imaging apparatus 11, the X-ray detection unit 35 detects the X-rays that have passed through the object, and the X-ray image data generation unit 36 generates X-ray image data based on the result of the detection. Then, the X-ray image data transmission unit 37 transmits the generated X-ray image data to the image processing apparatus 16 (S314). This X-ray image data is transmitted in accordance with the communication parameters for the image data communication that were set in the process of S307.

As has been described above, in Embodiment 1, the X-ray imaging is permitted only when the success of transmission of the taken X-ray image data is guaranteed. This can prevent an increase in the amount of time required to transmit the X-ray image data and the loss of the image data, thus preventing the examinee from experiencing unnecessary exposure.

### Embodiment 2

A description is now given of Embodiment 2. Embodiment 2 describes processing for setting communication parameters when the X-ray imaging is executed multiple times in sequence. Note that the X-ray imaging is executed multiple times when one examinee is subjected to the X-ray imaging while switching between body parts to be imaged or between imaging conditions, and when different examinees are subjected to a similar X-ray imaging in turn.

Assuming the case where the effect of noise on a wireless communication path lasts for some time; if the synchronous communication is performed with the communication parameters restored back to the original settings each time the imaging is executed, then there is a high possibility that the operator needs to press down the irradiation switch multiple times each time the imaging is executed.

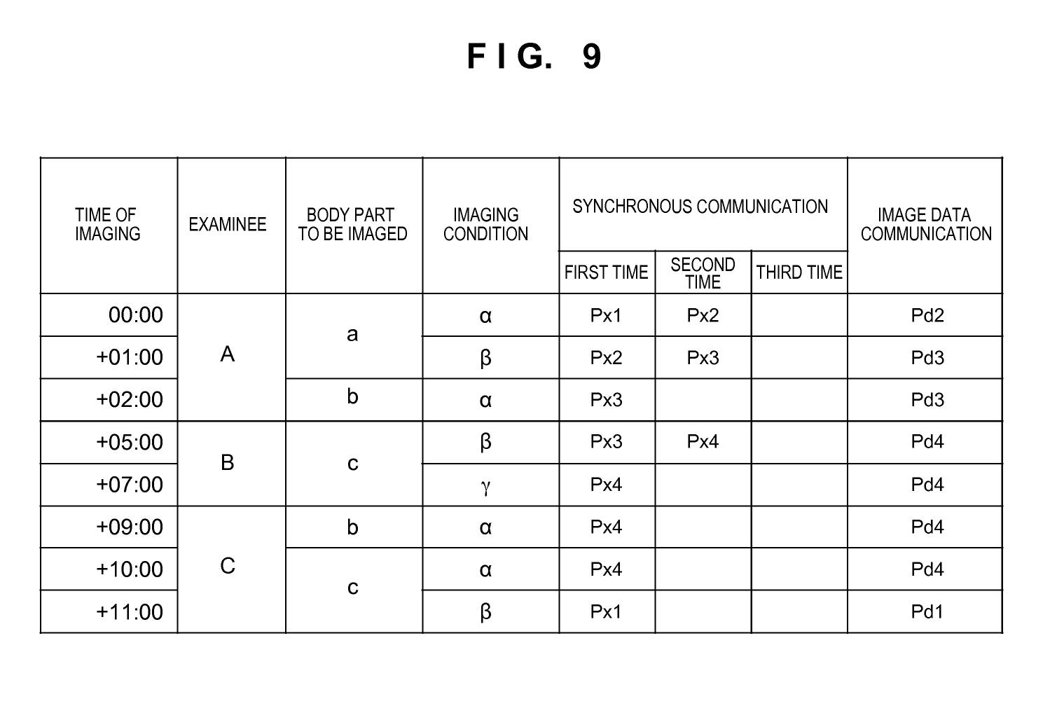

In view of this, the settings of the communication parameters are applied over multiple imaging processes. Here, the X-ray generation apparatus 13 (network IF apparatus 14) holds the values set to the communication parameters for a predetermine time period. As one example, the following describes the case where the predetermined time period is 10 minutes with reference to FIG. 9. To simplify the explanation, only the packet length is discussed below as one example of the communication parameters. However, the same goes for the other communication parameters.

At the reference time of 00:00, the imaging is started for the examinee A. Here, a body part to be imaged is a, and an imaging condition is α. It is assumed here that, after the synchronous communication was performed at first with Px1 [byte], it did not succeed within the timeout period, and therefore it was performed for the second time with Px2 [byte] as instructed by the operator and succeeded. Thereafter, the image data communication is performed with Pd2 [byte]. As has been mentioned earlier, Px1, Px2 and Pd2 satisfy the relationship Px1≧Px2≧Pd2.

Next, the imaging condition is changed to β and the second image is taken (after one minute). At this time, the synchronous communication is performed with Px2 [byte] that made the previous imaging succeed. It is assumed here that the synchronous communication has failed with Px2 [byte] and is therefore performed again with Px3 [byte]. As a result, the synchronous communication succeeds, and therefore the image data communication is performed with Pd3 [byte].

Then, after changing the body part to be imaged to b and the imaging condition to α, the third image is taken (after two minutes). The synchronous communication performed with Px3 [byte] succeeds, and therefore the image data communication is performed with Pd3 [byte] as with the case of the second image data.

When the imaging for the examinee A is completed, a body part to be imaged and an imaging condition are set for the examinee B, and the imaging is started for the examinee B (after five minutes). As in the above description, the synchronous communication is performed with Px3 [byte] that made the previous imaging (the third image for the examinee A) succeed. Thereafter, the communication parameters for the synchronous communication and the image data communication are set as in the above description.

When the imaging for the examinee B is completed, the imaging similar to the above-described imaging is started for the examinee C (after nine minutes). In this case also, the synchronous communication is performed with Px4 [byte] that made the previous imaging (the second image for the examinee B) succeed. The second image for the examinee C is taken (after 10 minutes) using the communication parameters that made the previous imaging succeed.

The third image for the examinee C is taken after the predetermined time period (in the present example, 10 minutes) has elapsed since the reference time. In this case, the values that had been set to the communication parameters up to that point are reset (i.e. restored back to default values). Hence, Px1 [byte] is used in the synchronous communication performed after the predetermined time period has elapsed. Thereafter, the communication parameters are set as in the above description.

Although the predetermined time period has been described as 10 minutes in Embodiment 2, the predetermined time period is of course not limited to 10 minutes and may be changed as appropriate. Furthermore, a time period during which the values set to the communication parameters are held (the predetermined time period) may be set for each imaging condition, each body part to be imaged, each examinee, or any combination of these. Moreover, the above processing may be executed under the assumption that the time when the settings of the communication parameters were updated most recently serves as the reference time for the time period during which the values set to the communication parameters are held (the predetermined time period).

As has been described above, in Embodiment 2, the values set to the communication parameters are held during the predetermined time period. This can suppress the situation in which unexpected values are set to the communication parameters when the X-ray imaging is executed multiple times in sequence.

This concludes the description of representative examples of embodiments according to the present invention. However, the present invention is not limited to the embodiments described above and illustrated in the drawings, and may be modified as appropriate without changing the substance thereof.

In the above embodiments, the values set to the communication parameters are changed by reducing/increasing them in order to satisfy the relationship between the synchronous communication and the image data communication (the relationship between high and low tolerances for noise). However, the present invention is not limited in this way. Alternatively, for example, the values set to the communication parameters may be changed by applying multiplication/division to them or through on/off operations.

Furthermore, although the above embodiments have described the examples in which the wireless communication is performed under the infrastructure mode where the wireless communication is performed via an access point, the present invention is not limited in this way. For example, the present invention can be similarly applied to the configuration in which the wireless communication is performed under the ad-hoc mode where apparatuses wirelessly communicate with one another without using the access point.

### Other Embodiments

Aspects of the present invention can also be realized by a computer of a system or apparatus (or apparatuses such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-231099, filed Oct. 20, 2011, which is hereby incorporated by reference herein in its entirety.

What is claimed is:

1. A radiation imaging system comprising:
a synchronous communication unit configured to perform synchronous communication for taking a radiation image via a wireless communication path before radiation is irradiated;
a determination unit configured to determine that the radiation is to be irradiated when the synchronous communication has been performed, and that the radiation is not to be irradiated when the synchronous communication has not been performed; and
a radiation image communication unit configured to perform radiation image communication for transmitting the radiation image via the wireless communication path after the radiation is irradiated,
wherein values of communication parameters for the radiation image communication are set so as to exhibit the same or a higher tolerance for noise on the wireless communication path compared to values set to communication parameters for the synchronous communication.

2. The radiation imaging system according to claim 1, further comprising
a parameter determination unit configured to, when the determination unit has determined that the radiation is not to be irradiated, re-set values of communication parameters for the synchronous communication such that the re-set values exhibit the same or a higher tolerance for noise on the wireless communication path compared to values previously set to communication parameters for the synchronous communication.

3. The radiation imaging system according to claim 2,
wherein for a predetermined time period, the parameter determination unit repeats the re-setting each time the determination unit determines that the radiation is not to be irradiated, and
when the predetermined time period has elapsed, the parameter determination unit restores values set to communication parameters for the synchronous communication back to default values and performs the re-setting again.

4. The radiation imaging system according to claim 1, further comprising
a timer unit configured to measure time from when the synchronous communication is started to when the synchronous communication is completed,
wherein the determination unit determines that the radiation is to be irradiated when the synchronous communication is performed within a timeout period measured by the timer unit.

5. The radiation imaging system according to claim 1,
wherein the communication parameters include at least one of a packet length, an output signal intensity and a transfer rate.

6. A processing method for a radiation imaging system, comprising:
a synchronous communication step of performing synchronous communication for taking a radiation image via a wireless communication path before radiation is irradiated;
a determination step of determining that the radiation is to be irradiated when the synchronous communication has been performed, and that the radiation is not to be irradiated when the synchronous communication has not been performed; and
a radiation image communication step of performing radiation image communication for transmitting the radiation image via the wireless communication path after the radiation is irradiated,
wherein values of communication parameters for the radiation image communication are set so as to exhibit the same or a higher tolerance for noise on the wireless communication path compared to values set to communication parameters for the synchronous communication.
